(19) United States
(12) Patent Application Publication
(10) Pub. No.: US 2004/0011157 A1
(43) Pub. Date: Jan. 22, 2004

(54) Vehicle steering wheel

(75) Inventors: Constantin Hauer, Schollkrippen (DE); Alexander Limberger, Offenbach/Main (DE)

Correspondence Address: TAROLLI, SUNDHEIM, COVELL, TUMMINO & SZABO L.L.P., 526 SUPERIOR AVENUE, 1111 LEADER BLDG., CLEVELAND, OH, 44114-1400, US

(73) Assignee: TRW Automotive Safety Systems GmbH

(21) Appl. No.: 10/617,291

(22) Filed: Jul. 10, 2003

(30) Foreign Application Priority Data
Jul. 16, 2002 (DE) 202 10 741.8

(51) Int. Cl. B62D 1/04

(52) U.S. Cl. 74/552

(57) ABSTRACT

A vehicle steering wheel comprises a skeleton and a first detent element as part of a detent connection for a gas bag module which is able to be connected to the skeleton. At least one separate support component is arranged on the skeleton. The support component carries a detent pin as the first detent element which can engage into a second detent element arranged on the gas bag module and complementary to the detent pin.

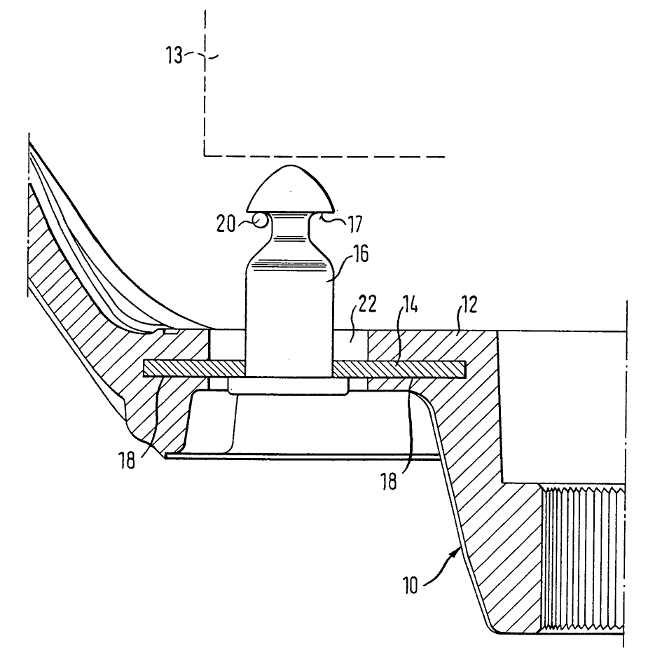

### TECHNICAL FIELD

The invention relates to a vehicle steering wheel.

### BACKGROUND OF THE INVENTION

A vehicle steering wheel provided with a gas bag module usually comprises a skeleton and a detent element as part of a detent connection for the gas bag module which is able to be connected to the skeleton.

In recent years it has been found that in particular detachable connections between the gas bag module and the steering wheel, with the use of detent elements arranged on the module and on the steering wheel skeleton, satisfy the requirements which regard to safety technology. These connections are distinguished by the module being easy to install.

The invention provides an improvement to a steering wheel with such a detent connection; in particular it provides for a reduced structural volume.

### BRIEF SUMMARY OF THE INVENTION

According to the invention, a vehicle steering wheel comprises a skeleton and a first detent element as part of a detent connection for a gas bag module which is able to be connected to the skeleton. At least one separate support component is arranged on the skeleton. The support component carries a detent pin as the first detent element which can engage into a second detent element arranged on the gas bag module and complementary to the detent pin. Through the use of a support component, the necessary stability of the steering wheel skeleton can be easily achieved, so that the base of the steering wheel hub can be constructed very simply and at the same time has a high degree of stability. The construction according to the invention also makes it possible to arrange a normally space-intensive unlocking mechanism on the gas bag module, whereby in the region of the hub base only a minimum structural space has to be available.

Preferably, the support component is a metal plate.

During casting the skeleton, the support component is usually embedded therein.

Preferably, the skeleton is provided with a recess around the detent pin, the support component even being able to be exposed, in order to save space.

### BRIEF DESCRIPTION OF THE DRAWING

The single FIGURE shows a sectional view of a cut-out of a steering wheel according to the invention.

### DETAILED DESCRIPTION OF THE PREFERRED EMBODIMENT

The skeleton 10 of the steering wheel has a hub region 12 with a hub base, which forms the lower part of a cavity to receive a gas bag module 13, and is only shown in outline here.

Fastened to the skeleton 10 are preferably several assemblies made up of one support component 14 and one detent pin 16 in each case; the latter forms a first detent element and is securely connected in a suitable known manner with the support component 14.

During casting, the support component 14 is placed into the mold and, hence, embedded in the skeleton 10 in the regions 18. The support component 14 preferably consists of a metal plate. Around the detent pin 16, the skeleton 10 has a recess 22, so that the support component 14 is partially exposed.

In the finished steering wheel, the detent pin 16, the support component 14 and the hub region 12 are firmly connected with each other.

The detent pin 16 can have any shape which is suitable to enter into a detent connection with a complementary detent element. In the example shown here, a detent surface 17 is formed at the head of the detent pin.

The gas bag module 13 has second detent elements 20 complementary to the detent pin 16, which are preferably fastened to the underside of the gas bag module and are realized for example by a spring wire in each case. On pushing the gas bag module 13 into the cavity of the steering wheel, the detent element 20 enters into a detent connection with the detent surface 17 of the detent pin 16. Preferably, an unlocking mechanism (not shown here) is provided on the gas bag module 13, via which the gas bag module can be detached from the steering wheel again.

1. A vehicle steering wheel comprising a skeleton and a first detent element as part of a detent connection for a gas bag module which is able to be connected to said skeleton,
at least one separate support component being arranged on said skeleton, said support component carrying a detent pin as said first detent element which can engage into a second detent element arranged on said gas bag module and complementary to said detent pin.

2. The vehicle steering wheel according to claim 1, wherein said skeleton of said steering wheel comprises a hub cup on which said support component is arranged.

3. The vehicle steering wheel according to claim 1, wherein said support component is a metal plate.

4. The vehicle steering wheel according to claim 1, wherein said support component and said detent pin form a prefabricated assembly.

5. The vehicle steering wheel according to claim 1, wherein said support component is embedded into said skeleton which is made of cast metal.

6. The vehicle steering wheel according to claim 5, wherein said skeleton has a recess around said detent pin.
